(19) United States
(12) Patent Application Publication
(10) Pub. No.: US 2026/0195384 A1
(43) Pub. Date: Jul. 9, 2026

(54) METHOD AND DEVICE WITH QUESTION-ANSWERING MODEL TRAINING

(71) Applicants: Samsung Electronics Co., Ltd., Suwon-si (KR); Korea University Research and Business Foundation, Seoul (KR)

(72) Inventors: Junyeon LEE, Suwon-si (KR); Changwook CHU, Seoul (KR); Seoungbum KIM, Seoul (KR); Jaehoon KIM, Seoul (KR); Byungwoo BANG, Suwon-si (KR); Uiseok SONG, Suwon-si (KR); Jungmin LEE, Goyang-si (KR); Yongtae JEONG, Seoul (KR); Hansam CHO, Seoul (KR)

(73) Assignees: Samsung Electronics Co., Ltd., Suwon-si (KR); Korea University Research and Business Foundation, Seoul (KR)

(21) Appl. No.: 19/247,173

(22) Filed: Jun. 24, 2025

(30) Foreign Application Priority Data
Jan. 3, 2025 (KR) 10-2025-0001024

(51) Int. Cl. G06F 16/9032; G06F 16/93

(52) U.S. Cl. CPC G06F 16/90332; G06F 16/93

(57) ABSTRACT

A method and device for training a retrieval augmented generation (RAG)-based question-answering (QA) model are provided. A method of training a RAG-based QA model includes obtaining question data and answer data associated with a document, extracting, based on a similarity between a query corresponding to the question data and each of reference documents, at least one reference document corresponding to the query from among the reference documents, and training the QA model to output the answer data as a response to the query based on the extracted reference document.

### CROSS-REFERENCE TO RELATED APPLICATIONS

This application claims the benefit under 35 USC § 119(a) of Korean Patent Application No. 10-2025-0001024, filed on Jan. 3, 2025, in the Korean Intellectual Property Office, the entire disclosure of which is incorporated herein by reference for all purposes.

### BACKGROUND

### 1. Field

The following description relates to a method and device with question-answering (QA) model training.

### 2. Description of Related Art

Large language models (LLMs) may be adopted in the development of question-answering (QA) systems. One typical technique to enhance the accuracy of these systems is retrieval augmented generation (RAG), which may generally be applied to improve the accuracy of answers to questions. RAG may retrieve external documents relevant to a given question and generate answers based on the retrieved documents, thereby increasing the reliability and accuracy of answers to questions generated through LLMs. Such QA systems are applicable to various industries, offering timely and context-relevant responses. Consequently, there is growing interest and ongoing research focused on improving the accuracy and effectiveness of these QA systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes obtaining question data and answer data associated with a document; extracting, based on a similarity between a query corresponding to the question data and each of a plurality of reference documents, at least one reference document corresponding to the query from among the plurality of reference documents; and training a retrieval-augmented generation (RAG)-based question-answering (QA) model to output the answer data as a response to the query based on the extracted reference document.

The obtaining of the question data and the answer data may include generating the question data and the answer data using a generative model.

The obtaining of the question data and the answer data may include generating the question data and the answer data using a generative model based on chain-of-thought (CoT) prompting corresponding to the document.

The extracting of the at least one reference document may include determining a similarity between embedding data of the query and embedding data of each of the reference documents.

The extracting of the at least one reference document may include obtaining a reference document identified by a retriever of the QA model as corresponding to the query.

The retriever may be fine-tuned to identify the document as the reference document corresponding to the query.

The extracting of the at least one reference document may include fine-tuning a retriever of the QA model to determine that the document is most similar to the query among the reference documents; and extracting the at least one reference document based on the similarity using the fine-tuned retriever.

The training of the QA model may include fine-tuning a generator of the QA model to output the answer data as a response to the query using a dataset comprising the extracted reference document.

The method may further include determining whether to include the document, which is a ground truth of the reference document corresponding to the query, in the dataset based on a predetermined probability.

The dataset may include a first dataset comprising at least one reference document extracted for a first query, and a first document which is a ground truth reference document for the first query; and a second dataset comprising at least one reference document extracted for a second query and excluding a second document which is ground truth reference document for the second query.

In one general aspect, provided is a non-transitory computer-readable storage medium storing instructions that, in response to being executed by one or more processors, cause the one or more processors to perform the method described herein.

In one general aspect, an electronic device includes one or more processors comprising processing circuitry; and memory comprising one or more storage media storing instructions that, when executed individually or collectively by one or more processors, cause the electronic device to: generate question data and answer data associated with a document; extract, based on a similarity between a query corresponding to the question data and each of reference documents, at least one reference document corresponding to the query from among the reference documents; and train a retrieval-augmented generation (RAG)-based question-answering (QA) model to output the answer data as a response the query based on the extracted reference document.

The instructions, in response to being executed by the one or more processors, may cause the electronic device to generate the question data and the answer data generated using a generative model.

The instructions, in response to being executed by the one or more processors, may cause the electronic device to generate the question data and the answer data using a generative model based on chain-of-thought (CoT) prompting corresponding to the document.

The instructions, in response to being executed by the one or more processors, may cause the electronic device to determine a similarity between embedding data of the query and embedding data of each of the reference documents.

The instructions, in response to being executed by the one or more processors, may cause the electronic device to obtain a reference document identified by a retriever of the QA model corresponding to the query.

The instructions, in response to being executed by the one or more processors, may cause the electronic device to: fine-tune a retriever of the QA model to determine that the document is most similar to the query among the reference documents; and extract the at least one reference document based on the similarity using the fine-tuned retriever.

The instructions, in response to being executed by the one or more processors, may cause the electronic device to fine-tune a generator of the QA model to output the answer data as a response to the query based on a dataset comprising the extracted reference document.

The instructions, in response to being executed by the one or more processors, may cause the electronic device to perform: determine whether to include the document, which is a ground truth of the reference document corresponding to the query, in the dataset based on a predetermined probability.

Other features and aspects will be apparent from the following detailed description, the drawings, and the claims.

### BRIEF DESCRIPTION OF THE DRAWINGS

FIG. 1 illustrates an example method of training a retrieval-augmented generation (RAG)-based question-answering (QA) model according to one or more embodiments.

FIG. 2 illustrates an example training framework of a RAG-based QA model according to one or more embodiments.

FIG. 3 illustrates an example operation of generating training data of a contextual augmented triplet synthesis for RAG (CATS-RAG) model according to one or more embodiments.

FIG. 4 illustrates an example configuration of a CATS-RAG model according to one or more embodiments.

FIG. 5 illustrates an example operation of a retriever of a CATS-RAG model for obtaining a dataset according to one or more embodiments.

FIG. 6 illustrates an example configuration of an electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

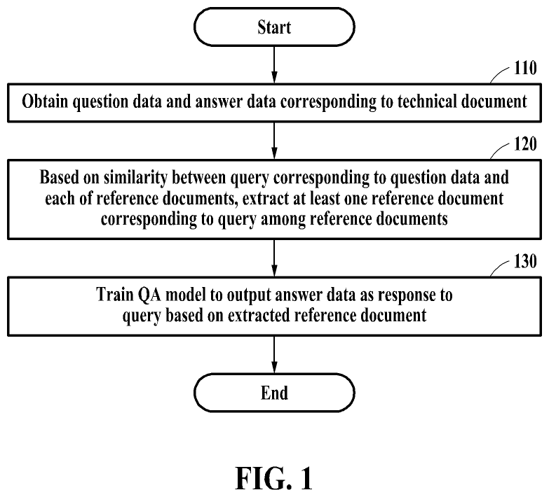

FIG. 1 illustrates an example method of training a retrieval-augmented generation (RAG)-based question-answering (QA) model according to one or more embodiments.

The QA model may be configured to generate a response to an input question. A RAG-based QA model may retrieve relevant information from a database (DB) and generate a response using the retrieved information. Hereinafter, the RAG-based QA model may be simply referred to as a “QA model” or a “model.”

The DB may store documents and/or information that may serve as references and/or sources of knowledge used in generating a response to a question input to the model. For example, the DB may store technical documents (e.g., research papers, system manuals, and the like). Hereinafter, these documents stored in the DB may be referred to as reference documents.

Training the RAG-based QA model may include fine-tuning a pre-trained RAG model. As an example, the training of the RAG-based QA model may include fine-tuning one or both of a retriever and a generator included in the RAG model.

A method of training the RAG-based QA model may be performed by one or more processors of an electronic device. The specific hardware configuration of the electronic device that performs the method of training the RAG-based QA model will be described below.

Referring to FIG. 1, the method of training the RAG-based QA model may include operation 110 of obtaining question data and corresponding answer data associated with a technical document. The technical document may pertain to a specific domain. For example, the technical document may include at least one of a document containing knowledge about a specific technical field, a scientific paper, and a system manual.

The question data corresponding to the technical document may be derived from or related to the contents of the technical document. The corresponding answer data may be generated based on the technical document or information derived from the technical document. Each question-answer pair may be associated with a particular technical document. One or more such pairs may be generated in response to one technical document.

A triplet comprising the technical document, the question data, and the answer data may be obtained in operation 110. The triplet may be stored as training data for training the model. The training data for the model may include one or more triplets.

According to one or more embodiments, operation 110 may include obtaining the question data and the answer data corresponding to the technical document using a generative model. The electronic device may apply the technical document to the generative model to generate the question data and the answer data.

The generative model may refer to an artificial intelligence neural network configured to generate new data (e.g. text, images, audio, and/or video) in response to user input (e.g. text or spoken utterance). The generative model may include, for example, any one or any combination of two or more of a large language model (LLM), a large multimodal model (LMM), a foundation model (FM), and a multi-modal foundation model (MMFM).

A prompt for requesting the generation of a question and an answer for a technical document may be input to the generative model along with the technical document.

According to one or more embodiments, operation 110 may include requesting the generative model to generate the question data and the answer data corresponding to the technical document using a chain-of-thought (CoT) prompting technique. CoT prompting will be described in detail below.

The method of training the RAG-based QA model may include, in operation 120, extracting at least one reference document corresponding to a query from among reference documents, based on a similarity between the query derived from the question data and each of the reference documents.

The question data may be input to the QA model as a query. The QA model may be trained to generate a response to the query using an appropriate reference document. The reference document to be used for the response generation of the QA model may be extracted. As described above, the reference document may be stored in a DB accessible by the QA model. For example, the reference document may pertain to a specific domain. For example, the reference document may include at least one of a document containing knowledge about a specific technical field, a paper on a specific technical field, and a manual for a specific system.

At least one reference document may be extracted from among the reference documents stored in the DB based on the similarity to the query. For example, the top n (where n is a natural number) reference documents or top m % (where m is a positive real number) reference documents with a high similarity to the query may be extracted/selected from among the reference documents stored in the DB.

According to one or more embodiments, operation 120 may include extracting the at least one reference document corresponding to the query from among the reference documents based on a similarity between embedding data of the query and embedding data of each of the reference documents. Based on the similarity, a predetermined number of reference documents with high similarity to the query may be extracted. For example, the similarity may include cosine similarity.

According to one or more embodiments, operation 120 may include retrieving a reference document from the reference documents using a retriever of the QA model. The retriever may include an encoder configured to obtain embedding data of the query and embedding data of the reference document. The retriever may extract a predetermined number of reference documents having a high similarity to the query by determining the similarity between the embedding data of the query and the embedding data of the reference document.

The retriever may be fine-tuned to identify the technical document used to generate the query as the reference document. The technical document is a technical document for which the question data corresponding to the query is generated in operation 110, and may correspond to ground truth of the reference document. In other words, the technical document may form a triplet with the question data corresponding to the query in the training data.

According to one or more embodiments, operation 120 may include fine-tuning a retriever of the QA model to determine that the technical document is most similar to the query among the reference documents, and extracting the at least one reference document corresponding to the query from among the reference documents based on the similarity between the query corresponding to the question data and each of the reference documents by the fine-tuned retriever. For example, the encoder of the retriever that generates the embedding data may be fine-tuned. The fine-tuning of the retriever will be described in detail below.

The method of training the RAG-based QA model may include, in operation 130, training the QA model to generate the answer data as a response corresponding to the query based on the extracted reference document. The QA model may be trained to output a response corresponding to the query by reflecting information included in the extracted reference document. More specifically, the generator of the QA model may be trained to output a response corresponding to the query by reflecting information included in the extracted reference document.

According to one or more embodiments, operation 130 may include fine-tuning the generator of the QA model to output the answer data in response to the query, using a dataset that includes the extracted reference document. The dataset is referenced by the generator to generate a response, and may include the at least one reference document extracted in operation 120. For example, the dataset may further include a technical document that forms a triplet with the question data and the answer data corresponding to the query.

The method of training the RAG-based QA model may further include an operation of determining whether to include the technical document which is the ground truth of the reference document corresponding to the query in the dataset based on a predetermined probability. In other words, the dataset may be determined to include the technical document with the predetermined probability. When it is determined that the technical document is included, the dataset may include the technical document along with the extracted reference document. When it is determined that the technical document is not included, the dataset may include the extracted reference document but not the technical document.

The dataset may include a plurality of datasets corresponding to a plurality of queries, respectively. For example, the dataset may include a first dataset corresponding to a first query and a second dataset corresponding to a second query. The first dataset may include at least one reference document extracted in response to the first query, and a first technical document which is ground truth of the reference document corresponding to the first query. The second dataset may include at least one reference document extracted in response to the second query, and may not include a second technical document that is ground truth of the reference document corresponding to the second query. For example, when the probability that the technical document is included in the dataset is P % and there are a sufficiently large number of datasets, P % of the datasets may include the reference document and the technical document, and (100−P) % of the datasets may include only the reference document without the technical document.

The fine-tuning of the generator of the QA model based on the dataset will be described below.

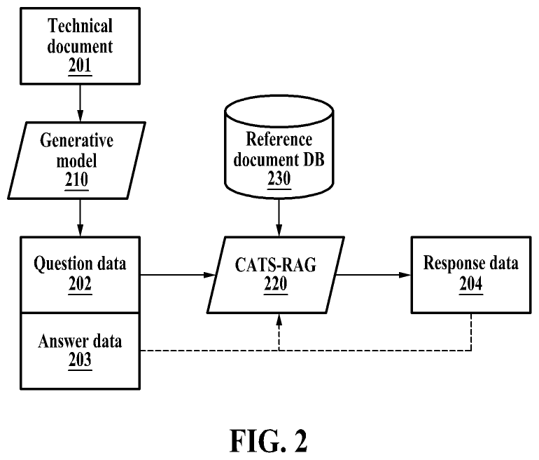

FIG. 2 illustrates an example training framework of a RAG-based QA model according to one or more embodiments.

Hereinafter, the RAG-based QA model may be referred to as a contextual augmented triplet synthesis for RAG (CATS-RAG) model 220.

Referring to FIG. 2, training data of the CATS-RAG model 220 may be generated using a generative model 210. The training data of the CATS-RAG model 220 may comprise a triplet including a technical document 201, and question data 202 and answer data 203 corresponding to the technical document 201. The generative model 210 may generate the question data 202 and the answer data 203 based on information on the technical document 201 and/or the content of the technical document 201.

As described above, the technical document 201 may pertain to a specific domain. By generating the question data 202 and the answer data 203 using the generative model 210 based on the technical document 201, the training data for a specific domain may be augmented.

The question data 202 may be input to the CATS-RAG model 220 as a query. The CATS-RAG model 220 may be trained to generate response data 204 for the input query using a reference document stored in a reference document DB 230.

The CATS-RAG model 220 may extract some reference documents corresponding to the query from the reference document DB 230 and use the extracted reference documents to generate the response data 204. The CATS-RAG model 220 may be trained to identify and extract a reference document with a high similarity to the question data 202 input as a query from among the reference documents stored in the reference document DB 230. For training purposes, the technical document 201, which is ground truth of the reference document corresponding to the question data 202, may be used for the training of the CATS-RAG model 220. The CATS-RAG model 220 may be trained to output the answer data 203 as the response data 204 for the input question data 202 using the extracted reference document. The training of the CATS-RAG model 220 will be described in detail below.

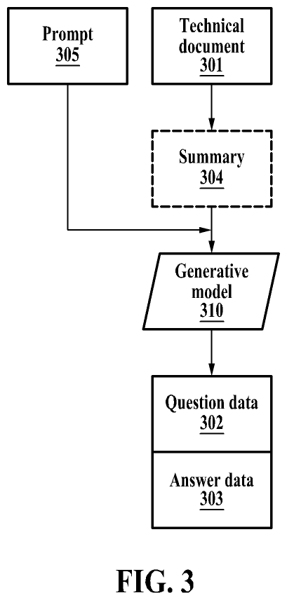

FIG. 3 illustrates an example operation of generating training data of a CATS-RAG model according to one or more embodiments.

Referring to FIG. 3, as described above, the training data of the CATS-RAG model may comprise a triplet including a technical document 301, question data 302, and answer data 303.

The training data for the CATS-RAG model may be generated using a generative model 310. The technical document 301 may be input to the generative model 310, which may generate the question data 302 and the answer data 303 based on information/content contained in the technical document 301.

In one or more embodiments, a summary 304 of the technical document 301 may be input to the generative model 310. The summary 304 may be generated using the generative model 310 or a language model such as a bidirectional auto-regressive transformer (BART)-based model or the like. The summary 304 may include essential information extracted from the technical document 301, which may contain a substantial amount of data. For example, the summary 304 may be free of extraneous elements such as HTML tags or codes that increase the document length included in the technical document 301. By inputting the summary 304 instead of the entire technical document 301 into the generative model 310, noise in the generative model 310 may be reduced and resource efficiency may be improved.

A prompt 305 for requesting the generation of the question and the answer based on the technical document 301 may be input to the generative model 310, together with one or both of the technical document 301 and the summary 304 of the technical document 301. As an example, the prompt 305 may include a CoT prompt generated through CoT prompting. The CoT prompt may include a prompt that instructs the generative model 310 to execute multiple sequential operations for obtaining the question data 302 and the answer data 303.

For example, the prompt 305 may include data requesting the generative model 310 to extract key terms corresponding to candidates for an answer from the input technical document 301 and/or the summary 304 of the technical document 301, generate a question based on the extracted candidates for the answer, generate the answer to the generated question using the technical document, and output the generated question and answer in a specific format.

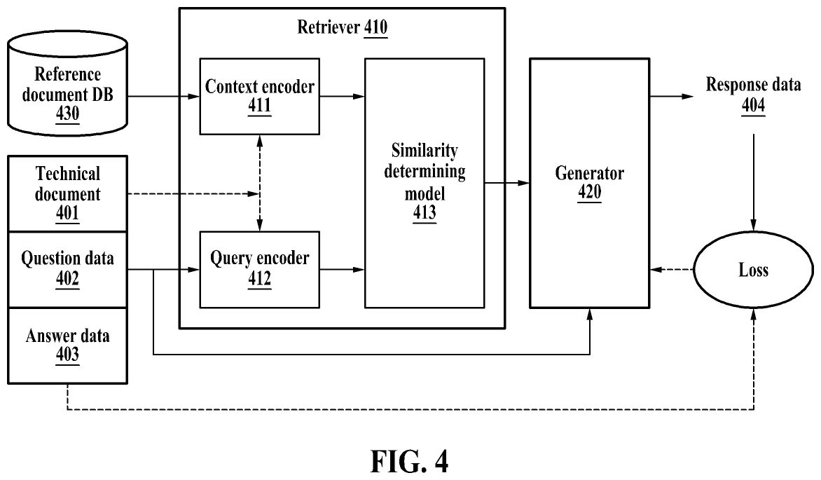

FIG. 4 illustrates an example configuration of a CATS-RAG model according to one or more embodiments.

Referring to FIG. 4, the CATS-RAG model may include a retriever 410 and a generator 420. The retriever 410 and the generator 420 may be fine-tuned to deliver consistently high QA performance within a specific domain.

The retriever 410 may include a context encoder 411 and a query encoder 412. For example, the context encoder 411 and the query encoder 412 may be each implemented, as a non-limiting example, using a bidirectional encoder representation from transformers (BERT)-based encoder. The context encoder 411 may encode a reference document stored in a reference document DB 430 and output embedding data corresponding to the reference document. The query encoder 412 may encode question data 402 corresponding to a query and output embedding data of the question data 402. The context encoder 411 and the query encoder 412 may map the question data 402 and the reference document to a shared embedding space.

The retriever 410 may determine, using a similarity determining model 413, a similarity (e.g., a similarity score) between the embedding data of the reference document output from the context encoder 411 and the embedding data of the question data 402 output from the query encoder 412. For example, a similarity, sim(Q, D) between the embedding data of the reference document and the embedding data of the question data 402 may be calculated by Equation 1 for example.

$$sim ( Q , D ) ∝ {{E}_{Q} ( Q )}^{T} {E}_{p} ( D ) \qquad Equation 1$$

In Equation 1, Q may represent the question data 402, D may represent the reference document, E_{Q} may represent the query encoder 412, and E_{P} may represent the context encoder 411. E_{Q}(Q) may represent the embedding data of the question data 402 which is the output of the query encoder 412, and E_{P}(D) may represent the embedding data of the reference document which is the output of the context encoder 411. The similarity sim(Q, D) between the embedding data of the reference document and the embedding data of the question data 402 may be determined as a dot product of the embedding data E_{Q}(Q) of the question data 402 and the embedding data E_{P}(D) of the reference document.

The retriever 410 may be trained to determine and output the embedding data of a technical document 401 forming a triplet with the question data 402 as similar to the embedding data of the question data 402. For example, the context encoder 411 and the query encoder 412 of the retriever 410 may be trained using contrastive learning. In such training, the more similar the reference document is to the technical document 401, the higher the similarity to the embedding data of the question data 402 is output, and the less similar the reference document is to the technical document 401, the lower the similarity to the embedding data of the question data 402 is output. In other words, the reference documents that are more similar to the technical document 401 may be mapped to embedding vectors with greater similarity to the embedding vector of the question data 402, whereas less similar reference documents may be mapped to embedding vectors with lower similarity.

The retriever 410 may be fine-tuned to determine the order of the reference documents based on the similarity to the question data 402 input as a query. The retriever 410 may align the reference documents in descending order of the similarity to the question data 402 and extract either (i) the top n (where n is a natural number) reference documents, or (ii) top m (where m is a positive real number) percent of reference documents, as most similar to the question data 402.

The retriever 410 may provide a dataset including the extracted reference documents to the generator 420 for subsequent processing.

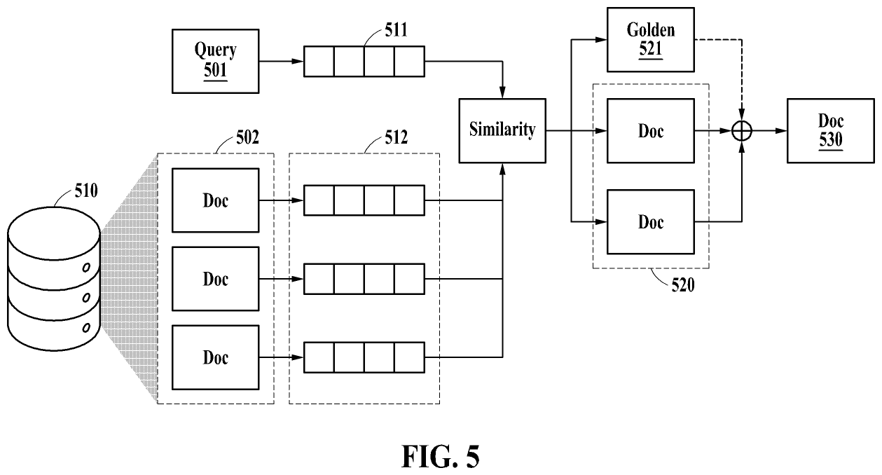

For example, referring to FIG. 5, a retriever of a CATS-RAG model may determine a similarity between embedding data 511 of a query 501 corresponding to question data and embedding data 512 for each of reference documents 502 stored in a reference document DB 510.

The retriever of the CATS-RAG model may extract the top k (k is a natural number) reference documents 520 that exhibit a high similarity to the embedding data 511 of the query 501 based on the similarity determination results.

The top k reference documents 520 may be included in a dataset 530 used for training a generator of the CATS-RAG model. The dataset 530 may include golden data 521, which serves as ground truth of the reference document for the query 501 with a predetermined probability. The golden data 521 may correspond to a technical document that forms a triplet with the question data corresponding to the query 501.

The golden data may be included in the dataset 530 with a probability of P percent, where P is a predetermined probability value. Accordingly, the dataset 530 may include or omit the golden data 521 in different embodiments.

Hereinafter, question data input as the query 501 may be represented as Q, a technical document corresponding to the question data may be represented as D*, and a reference document obtained from the reference document DB may be represented as D. D* may correspond to the golden data 521.

The retriever of the CATS-RAG model may identify D* for question data Qᵢ input as the query 501. The retriever may be trained to extract D* as a document most similar to the query 501 by comparing the embedding similarity between the query 501, and the technical document and the reference document. The fine-tuned retriever may retrieve or extract a predetermined number (e.g., k) of reference documents (D₁, . . . , Dₖ) for the input query Qᵢ. The retriever may determine the order of the reference documents (D₁, . . . , Dₖ) based on the similarity to Qᵢ.

The training performance of the CATS-RAG model may be improved by using the top k reference documents 520 ranked by the similarity instead of using randomly extracted reference document(s). The randomly extracted reference documents are easily distinguished from D* in the CATS-RAG model. Meanwhile, the top k reference documents 520 ranked by the similarity to the query are not D* but include similar contents to D*, making it difficult to distinguish the reference documents 520 from D* in the CATS-RAG model, which may improve the performance of the contrastive learning of the CATS-RAG model.

The dataset 530 corresponding to Qᵢ, Dᵢ=[D*, D₁, . . . , Dₖ] or Dᵢ=[D₁, . . . , Dₖ], may be provided as an input for the fine-tuning of the generator. To introduce additional complexity and enhance model robustness, D* may be included in an input dataset of the generator with the probability of P percent. P percent of the dataset 530 may be formed with D*+D₁+ . . . +Dₖ, whereas (100−P) percent of the dataset 530 may be formed with D₁+ . . . +Dₖ excluding D*.

Referring again to FIG. 4, the generator 420 may be fine-tuned to output response data 404 corresponding to the question data 402 based on a dataset that includes reference documents extracted from the retriever 410 and probabilistically the technical document 401. For example, the generator 420 may be trained to output answer data 403 that forms a triplet with the question data 402.

For example, the generator 420 may be trained based on a token-level loss regarding a calculated token generation probability for a set of retrieved or extracted reference documents. For example, RAG-Token-Loss, which is a token-level loss for the training of the generator 420, may be defined as in, for example, Equation 2.

$${P}_{RAG - Token - Loss} ( y \vert x ) = \text{?} {P}_{η} ( z \vert x ) {P}_{θ} ( \text{?} ) \qquad Equation 2$$

$$\text{?} \text{indicates text missing or illegible when filed}$$

In Equation 2, P_{η}(z|x) may represent a probability of selecting a reference document z from the extracted reference document(s), and P_{θ}(yᵢ|x,z,y_{1α-1}) may represent a probability of generating a token yᵢ when the reference document z and a previous token are given.

The CoT prompting strategy may be applied during the fine-tuning of the generator 420 of the CATS-RAG model to enhance the ability of the generator 420 to generate contextually rich and logically consistent answers. In other words, the CoT prompt may be used to train the generator 420 to generate the response data 404 corresponding to the input question data 402. By inducing the generator 420 to perform step-by-step reasoning during the training process, the CoT prompting may enable the generator 420 to generate more accurate answers and to articulate the logical steps leading to each conclusion.

For example, a template of a prompt input to the generator 420 used during the fine-tuning of the CATS-RAG model may take the following form: “#query #{query} #passage #{passage} #instruction #Pleas provide the answer and logical inference considering the query and context above. Please use the following format: #answer #. #answer #.” This template provides a structured prompt designed to encourage explicit reasoning in the response generated by the model.

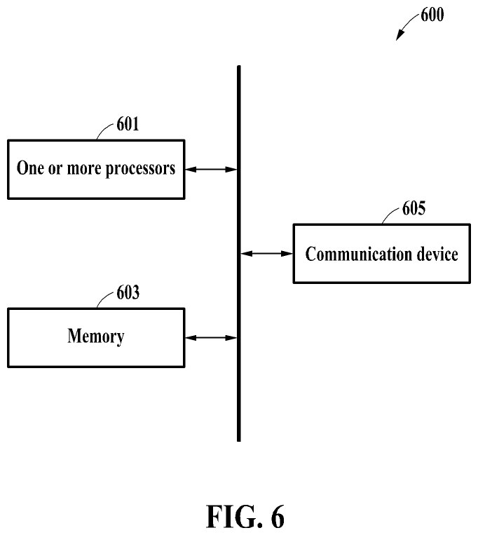

FIG. 6 illustrates an example configuration of an electronic device according to one or more embodiments.

Referring to FIG. 6, an electronic device 600 may include one or more processors 601, a memory 603, and a communication device 605. The electronic device 600 may be configured to perform at least a portion of the method of training the RAG-based QA model described above with reference to FIGS. 1 through 5.

The one or more processors 601 may be configured to execute one or more operations of the method of training the RAG-based QA model. For example, the one or more processors 601 may perform one or more of: obtaining question data and answer data corresponding to a technical document, based on a similarity between a query corresponding to the question data and each of reference documents, extracting at least one reference document corresponding to the query from among the reference documents, and training the QA model to output the answer data as a response corresponding to the query based on the extracted reference document.

The memory 603 may comprise a volatile memory (e.g., RAM) or a non-volatile memory (e.g., flash storage) and may store data associated with the training of the RAG-based QA model described above with reference to FIGS. 1 through 5. For example, the memory 603 may store data generated during the process of performing the method of training the RAG-based QA model described above with reference to FIGS. 1 through 5 or data required to perform the method of training the RAG-based QA model.

The communication device 605 may enable the electronic device 600 to communicate with external devices, including other electronic devices or servers, via a network. In other words, the electronic device 600 may be connected to an external device (e.g., a terminal of a user, a server, or a network) via the communication device 605 and exchange data with the external device.

According to an example, the memory 603 may not be physically part of the electronic device 600 and may instead reside in an external device accessible by the electronic device 600. For example, the memory 603 may include a reference document DB stored externally. In this case, the electronic device 600 may access the external memory 603 through the communication module 605 to retrieve or store data.

The memory 603 may store a program that implements the method of training the RAG-based QA model. The processor 601 may execute a program stored in the memory 603 to control the electronic device 600. Code of the program executed by the processor 601 may also be stored in the memory 603.

According to an example, the memory 603 may store instruction(s). The instruction(s) stored in the memory 603, when executed by one or more processors 601, may cause the electronic device 600 to: obtain question data and answer data corresponding to a technical document, based on a similarity between a query corresponding to the question data and each of reference documents, extract at least one reference document corresponding to the query from among the reference documents, and train a QA model to generate the answer data as a response corresponding to the query based on the extracted reference document.

The electronic device 600 may further include other components not shown in the drawings. For example, the electronic device 600 may further include an input/output interface including an input device and an output device as the means of interfacing with the communication device 605. In addition, for example, the electronic device 600 may further include other components such as a transceiver, various sensors, and a DB.

The electronic devices, computing devices, processors, memory, storage devices, processors 601, memory 603, communication device 605, and other apparatuses, devices, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software include higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method, the method comprising:
obtaining question data and answer data associated with a document;
extracting, based on a similarity between a query corresponding to the question data and each of a plurality of reference documents, at least one reference document corresponding to the query from among the plurality of reference documents; and
training a retrieval-augmented generation (RAG)-based question-answering (QA) model to output the answer data as a response to the query based on the extracted reference document.

2. The method of claim 1, wherein the obtaining of the question data and the answer data comprises generating the question data and the answer data using a generative model.

3. The method of claim 1, wherein the obtaining of the question data and the answer data comprises generating the question data and the answer data using a generative model based on chain-of-thought (CoT) prompting corresponding to the document.

4. The method of claim 1, wherein the extracting of the at least one reference document comprises determining a similarity between embedding data of the query and embedding data of each of the reference documents.

5. The method of claim 1, wherein the extracting of the at least one reference document comprises obtaining a reference document identified by a retriever of the QA model as corresponding to the query.

6. The method of claim 5, wherein the retriever is fine-tuned to identify the document as the reference document corresponding to the query.

7. The method of claim 1, wherein the extracting of the at least one reference document comprises:
fine-tuning a retriever of the QA model to determine that the document is most similar to the query among the reference documents; and
extracting the at least one reference document based on the similarity using the fine-tuned retriever.

8. The method of claim 1, wherein the training of the QA model comprises fine-tuning a generator of the QA model to output the answer data as a response to the query using a dataset comprising the extracted reference document.

9. The method of claim 8, further comprising:
determining whether to include the document, which is a ground truth of the reference document corresponding to the query, in the dataset based on a predetermined probability.

10. The method of claim 8, wherein the dataset comprises:
a first dataset comprising at least one reference document extracted for a first query, and a first document which is a ground truth reference document for the first query; and
a second dataset comprising at least one reference document extracted for a second query and excluding a second document which is ground truth reference document for the second query.

11. A non-transitory computer-readable storage medium storing instructions that, in response to being executed by one or more processors, cause the one or more processors to perform the method of claim 1.

12. An electronic device comprising:
one or more processors comprising processing circuitry; and memory comprising one or more storage media storing instructions that, when executed individually or collectively by one or more processors, cause the electronic device to:
obtain question data and answer data associated with a document;
extract, based on a similarity between a query corresponding to the question data and each of reference documents, at least one reference document corresponding to the query from among the reference documents; and
train a retrieval-augmented generation (RAG)-based question-answering (QA) model to output the answer data as a response the query based on the extracted reference document.

13. The electronic device of claim 12, wherein the instructions, in response to being executed by the one or more processors, cause the electronic device to generate the question data and the answer data using a generative model.

14. The electronic device of claim 12, wherein the instructions, in response to being executed by the one or more processors, cause the electronic device to generate the question data and the answer data using a generative model based on chain-of-thought (CoT) prompting corresponding to the document.

15. The electronic device of claim 12, wherein the instructions, in response to being executed by the one or more processors, cause the electronic device to determine a similarity between embedding data of the query and embedding data of each of the reference documents.

16. The electronic device of claim 12, wherein the instructions, in response to being executed by the one or more processors, cause the electronic device to obtain a reference document identified by a retriever of the QA model corresponding to the query.

17. The electronic device of claim 16, wherein the retriever is fine-tuned to identify the document as the reference document corresponding to the query.

18. The electronic device of claim 12, wherein the instructions, in response to being executed by the one or more processors, cause the electronic device to:
fine-tune a retriever of the QA model to determine that the document is most similar to the query among the reference documents; and
extract the at least one reference document based on the similarity using the fine-tuned retriever.

19. The electronic device of claim 12, wherein the instructions, in response to being executed by the one or more processors, cause the electronic device to fine-tune a generator of the QA model to output the answer data as a response to the query based on a dataset comprising the extracted reference document.

20. The electronic device of claim 19, wherein the instructions, in response to being executed by the one or more processors, cause the electronic device to perform:
determine whether to include the document, which is a ground truth of the reference document corresponding to the query, in the dataset based on a predetermined probability.
